(19) United States
(12) Patent Application Publication
(10) Pub. No.: US 2019/0007400 A1
(43) Pub. Date: Jan. 3, 2019

(54) METHOD FOR AUTHENTICATION VIA A COMBINATION OF BIOMETRIC PARAMETERS

(71) Applicant: TOC S.A., Providencia Santiago (CL)

(72) Inventor: Ricardo NAVARRO LUFT, Providencia Santiago (CL)

(21) Appl. No.: 16/063,556

(22) PCT Filed: Dec. 18, 2015
(86) PCT No.: PCT/CL2015/050052

§ 371 Date: Jun. 18, 2018

(51) Int. Cl. H04L 29/06; H04L 9/32

(52) U.S. Cl. CPC H04L 63/0861; H04L 63/083; H04L 9/3231

(57) ABSTRACT

The invention relates to a method for verifying the identity of a user who is carrying out a transaction, based on a combination of biometric parameters, in particular fingerprint detection, defined as a biometric PIN, comprising the provision of a biometric device that permits the reading of the digital fingerprint, and a sequential combination of fingerprints previously registered in a registration process, wherein the user can use said combination of fingers or digital fingerprints on the device for authentication, by means of the following steps: accessing an application previously installed on the device, wherein the biometric reader is activated; placing each finger or fingerprint previously selected in the registration process on the device in a selected sequential combination, wherein each finger should have a positive correspondence or match to continue with the next finger; once the fingers forming the PIN have been placed in the correct order and with a positive match for each finger, the identity verification data (date and time, unique serial number and GPS position) of the user is encrypted, if the identification is positive; and authorizing the transaction or action.

### FIELD OF APPLICATION

The present invention relates to the field of telecommunications and information handling, particularly to the verification of identities and authentication of a person, to increase the safety in transactions between a user and a transaction point or system from an institution, or other services requiring the approval from a user to carry out an action.

### BACKGROUND OF THE INVENTION

One of the main concepts at the time of effecting transactions or any other activity of any kind between a user and a specific point is the safety of said transaction or activity. There is a high risk that during this kind of activities information is lost or a third party can take data therefrom and make subsequent malicious use of said data.

Nowadays, one of the most used technologies is the use of the recognition of some biometric parameter to identify the user. However, the use of only one biometric parameter has been unsafe. In this sense, biometric recognition solutions have been proposed, which require the identification of two different biometric parameters, for example, fingerprint and retina. The document U.S. Pat. No. 9,053,310 describes a system and method that includes receiving a first biometric profile and associating the first biometric profile with a first application instance that is assigned as an authentication device of a first account; receiving a second biometric profile for a second application instance, wherein the second application instance is making a request on behalf of the first account; comparing the second biometric profile to the first biometric profile; and completing the request of the second application instance according to results of comparing the second biometric profile to the first biometric profile.

On the other hand, the document U.S. Pat. No. 7,130,452 is related to a system and method for multi-party authentication. The multi-party authentication process uses synchronous and persistent biometrics signals received from parties to a transaction, based on a policy, to approve a transaction request. The biometrics signals preferably are expressed as compressed video signals having response data. Several business applications are described that are based on the multi-party authentication engine.

This kind of solution makes the security increase of the transferred data possible.

### Technical Problem

The main technical problem posed by solutions with multiple biometric recognition is the fact that said recognition becomes more complex, since when using at least two different biometric parameters, it is necessary to have differentiated devices for each biometric parameter, which makes the process of recognition slower and more expensive. On the other hand, a greater amount of information must be stored prior to recognition, i.e., a greater number of different biometric parameters should be enrolled to be able to use this type of recognition.

### Technical Solution

In order to increase the safety in transitions systems between a user and a transaction point a method is suggested, which allows verifying the identity of a user that is carrying out a transaction from a combination of biometric parameters, particularly, fingerprint detection.

The method comprises the combination of one or more fingerprints in order to be able to perform the identification of a user. This identification will be made in a fixed or mobile device, which includes a fingerprint reader. The advantage of this solution lies in the fact that it does not require more than one type of biometric device to perform the identification.

### BRIEF DESCRIPTION OF THE DRAWINGS

FIG. 1 consists in a diagram of the method according to a preferred embodiment of the invention.

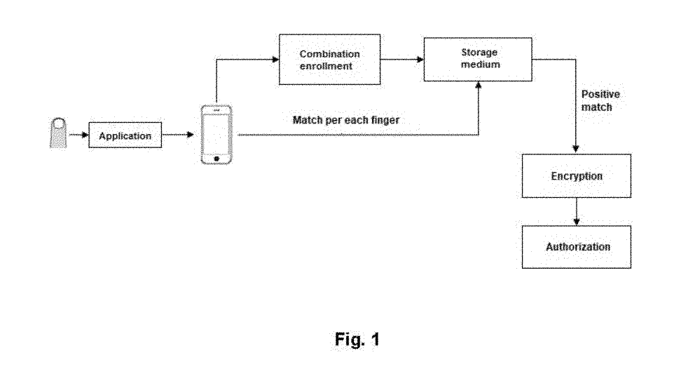

### DETAILED DESCRIPTION OF THE INVENTION

The present invention relates to a method for verifying the identity of a user that is carrying out a transaction, based on a combination of biometric parameters, particularly, fingerprint detection. Said method is defined under the use of a biometric PIN. In the first place, the user shall have a biometric device (1) that allows the reading of his digital fingerprint. Said biometric device (1) can be a mobile device comprising a location system or GPS. Subsequently, the enrollment of a combination of fingerprints (2) shall be performed, where said combination comprises at least two fingerprints in sequence. In this sense, the possible combinations are associated with the number of fingerprints available, i.e., a maximum of ten.

The enrolled combination (2) is stored in at least one storage medium (3). Said storage medium (3) can be in the cloud, a server, or the same fixed or mobile device (1). In this way, after enrollment and storage of the combination/sequence, the user can use said combination of fingers or fingerprints on the device (1) to authenticate himself by the following steps:

accessing an application (10) previously installed in the device, wherein the biometric reader is activated;

placing each finger (11) previously selected in the enrollment process in the selected sequence on the device (1), wherein each finger shall have a positive correspondence or match to continue with the next finger;

once the fingers forming the PIN have been placed (for example, left index/right thumb/right index) in the correct order and with a positive match for each finger, the identity verification data (date and time, unique serial number and GPS* position) of the user is encrypted, if the identification is positive, and

authorizing (13) the transaction or action in the device.

In the case of the use of GPS, this is only carried out if the device comprises a GPS system.

1. A method for verifying the identity of a user that is carrying out a transaction, based on a combination of biometric parameters, particularly, fingerprint detection defined as biometric PIN, CHARACTERIZED in that said method comprises arranging a biometric device that allows the reading of the user's digital fingerprint, and a sequential combination of fingerprints previously enrolled in an enrollment process, where the user can use said combination of fingers or digital fingerprints on the device to authenticate himself by the following steps:
accessing an application previously installed in the device, wherein the biometric reader is activated;
placing each finger or fingerprint previously selected in the enrollment process in combination with the selected sequence on the device, wherein each finger shall have a positive correspondence or match to continue with the next finger;
once the fingers forming the PIN have been placed in the correct order and with a positive match for each finger, the identity verification data (date and time, unique serial number and GPS position, if available) of the user is encrypted, if the identification is positive, and
authorizing the transaction or action in the device.

2. The method for verifying the identity of a user according to claim 1, CHARACTERIZED in that the arranged device is a fixed or mobile device.

3. The method for verifying the identity of a user according to claim 1, CHARACTERIZED in that the enrollment process consists in enrolling a combination of digital fingerprints, wherein said combination comprises at least two in sequence.

4. The method for verifying the identity of a user according to claim 3, CHARACTERIZED in that the enrolled combination is stored in at least one storage medium.

5. The method for verifying the identity of a user according to claim 4, CHARACTERIZED in that said storage medium can be in the cloud, a server or the device itself.
